(19) United States
(12) Patent Application Publication
(10) Pub. No.: US 2006/0257683 A1
(43) Pub. Date: Nov. 16, 2006

(54) Stainless steel electrolytic coating

(76) Inventors: Pamela A. Polinski, North Huntingdon, PA (US); John M. Paulina, Level Green, PA (US)

Correspondence Address: William L. Krayer, 1771 Helen Drive, Pittsburgh, PA, 15216, US

(21) Appl. No.: 11/451,669

(22) Filed: Jun. 13, 2006

Related U.S. Application Data
(62) Division of application No. 10/389,836, filed on Mar. 17, 2003.
(60) Provisional application No. 60/366,194, filed on Mar. 21, 2002.

(51) Int. Cl. B32B 15/00; C25D 3/56

(52) U.S. Cl. 428/683; 205/255

(57) ABSTRACT

Stainless steel coatings are formed on metallic substrates by employing the metallic substrates as a cathode in an aqueous electrolyte containing chromium, nickel and iron in specified concentrations or ratios. A coumarin leveling agent is preferably used. A product is obtained having a coating comprising, in weight ratios, weight ratios chromium 6-15 : nickel 3-5 : iron 32-39; the product has the appearance and many of the properties of monolithic stainless steel.

### RELATED APPLICATION

This application is a division of application 10/389,836 filed Mar. 17, 2003, which incorporates and claims the full benefit of provisional application 60/366,194 filed Mar. 21, 2002.

### TECHNICAL FIELD

In an electrolytic bath, a metallic substrate is coated with the constituents of stainless steel. The invention includes steel and steel articles coated with a stainless steel composition as well as the process for making it, and the electrolytic bath.

### BACKGROUND OF THE INVENTION

Stainless steel is useful and desirable for many purposes, but, in a monolithic form, it is expensive. It would be beneficial for many purposes to have a practical method of providing a less expensive carbon steel with a coating of a stainless composition. The carbon steel could be a three-dimensional preform, or in the form of strip. In either case, the product should be able to withstand conventional forming techniques and procedures after coating which might generate microcracks, for example, at points of stress.

One of the difficulties in developing an electrolytic coating process for the deposition of stainless steel coatings is that formability is generally better without a coating, and corrosion protection is generally achieved by application of a coating. A major objective of the present invention therefore is to achieve a process capable of producing a coated sheet steel product which can be formed without significantly reducing the corrosion resistance imparted by the stainless steel coating.

A coating formed by electrodeposition which does not include chromium, nickel and iron would not normally be thought of as a stainless steel coating. Accordingly, various descriptions in the prior art of the deposition of chromium or chromium and nickel, or other combinations of metals other than chromium, nickel and iron, do not achieve the above described objective of making a stainless steel coated product. The following US patents describe the deposition of nickel and/or chromium: Lashmore U.S. Pat. No. 4,461,680, Tajima et al U.S. Pat. No. 4,142,948, Gyllenspitz et al U.S. Pat. No. 3,954,574, Safranek U.S. Pat. No. 2,990,343, and Yeshida U.S. Pat. No. 2,766,196.

We are aware, however, of a few workers in the prior art who used all three metals in an electrolytic bath for coating carbon steel. See, for example, “Deposition of Stainless Steel from Chloride Baths” by Larissa Domnikov, Metal Finishing, February 1970, pp 57-63. This article focuses on the addition of aluminum to the bath. See also U.S. Pat. No. 4,610,763 to Malcolm Law, which deposits a stainless-like coating on top of a nickel flash. See also Schiffmann et al U.S. Pat. No. 3,374,156. Larisson Dominikov, “Iron-Nickel-Chromium Baths” Metal Finishing, March 1964, pp 61-65; M. Sarojamma and T. L. Rama Char, “Electrodeposition of Iron-Chromium-Nickel Alloys, Metal Finishing, September 1972, pp 36-42, A. Gowri and B. A. Shenor, “Stress in Chromium-Nickel-Iron Alloy Deposits”, “Metal Finishing, June 1972, pp 30-34; “Iron-Chromium-Nickel Deposition” by S. Gowri, P. L. Elsie and B. A. Shenoi, Metal Finishing, December 1967, pp 67-70. A trimetal coating deposited from a dimethyl formamide/urea bath was heat treated, as described by M. El-Sarif et al in “Effect of Heat Treatment in Microstructure of Cr—Ni—Fe Coatings Prepared by Electrodeposition”, Materials Science Forum, vols. 163-165 (1994), pp 633-638, Trans-Tech Publications; Kagachika et al U.S. Pat. No. 4,673,471; Renton et al U.S. Pat. No. 4,093,521.

The reader may be interested in the prior art process described by Schaer in U.S. Pat. No. 2,927,066, which does not use a leveling agent. Also, where the sources for iron, chromium and nickel are sulfates, the processes of the prior art tend to be deficient in terms of coating adhesion and uniformity. See Machu et al U.S. Pat. No. 3,093,556 and Schiffman et al U.S. Pat. No. 3,374,156. The percent of chromium in a nickel chromium bath is controlled with the use of EDTA, in Stromatt et al U.S. Pat. No. 3,888,744.

### SUMMARY OF THE INVENTION

We have invented a method of coating a metallic substrate with stainless steel. Our method includes employing the metallic substrate as a cathode in an aqueous electrolytic bath comprising 35-65 grams per liter chromium chloride, 9-15 grams per liter nickel chloride, and 4-8 grams per liter ferrous chloride, and subjecting the bath, under agitation, to an electric current effective to simultaneously deposit chromium, nickel and iron as a coating on the substrate. The substrate preferably is carbon steel, which may or may not be precoated with copper or nickel such as by a nickel flash coating. The electrodeposition is effected by imposing a current of 50-500, more preferably 100-300, and most preferably 150-250 amperes per square foot of surface to be coated. Graphite or other conventional anodes may be used, but a stainless steel anode is preferred. A stainless steel anode is to an extent sacrificial and generally helps to maintain the chromium, nickel and iron contents of the bath within the desired range as they are deposited on the substrate. Also preferably, the pH is held at 0.8 to 2, more preferably 1-1.5, and a buffering agent is included in the bath, such as ammonium chloride. We have also found that the quality of the coating is improved by including one or more leveling agents, preferably coumarin. Citric acid also helps to keep the rate of deposition of the metals consistently in the desired proportions while simultaneously acting as a buffer. A small amount of hydrofluosilicic acid helps to maintain current efficiency by contributing to maintaining the chromium ions in the trivalent state.

Our process is preferably a continuous one, so a steel strip can be passed through the electroplating bath. We have found that if the three metals—chromium, nickel, and iron—are initially present in certain ranges of ratios, as detailed below, a coating on the substrate will be formed having the desired, but entirely different, ranges of ratios similar to stainless steel.

Our invention also includes a metallic substrate having a coating comprising, by weight, 12-30% chromium, 6-10% nickel, and 64-78% iron. The three metals are substantially evenly distributed. Preferably the coating will comprise 16-22% chromium, 7-9% nickel, and 71-76% iron, the coating having excellent brightness, adherence and levelness. The coating may also include small amounts of other metals such as copper, but preferably such other metals will not exceed 2% by weight of the coating. In any case, trivial amounts of other metals may enter the bath from various sources and be deposited on the cathodic substrate. Our preferred product is carbon steel having such a stainless steel coating 1-100, preferably 2-50, and most preferably 3-25 micrometers thick. Most preferably the product is in the form of a coated steel strip. Our coated steel strip is substantially free of microcracks in the coating. As is known in the art, microcracks are small cracks not visible to the unaided eye which sometimes form in electroplated coatings, and can run either vertical with respect to the substrate or parallel. The coating will preferably also be uniformly distributed, and the adherence of the coating will also be superior. Our coated product will exhibit corrosion resistance comparable to monolithic stainless steel.

### BRIEF DESCRIPTION OF THE DRAWINGS

FIG. 1 is a triangular depiction of metals concentration in the bath.

FIG. 2 is a triangular depiction of metals percentages in the coating.

### DETAILED DESCRIPTION OF THE INVENTION

We have conducted experiments which demonstrate our invention. In particular, an aqueous bath has been made up having the following components:

Bath A

| Ingredient | Amount |
|---|---|
| CrCl₃ | 50 g/L |
| NH₄Cl | 100 g/L |
| KCl | 50 g/L |
| NiCl₂ | 12 g/L |
| Citric Acid | 3 g/L |
| Hydrofluosilicic Acid | 2 g/L |
| TRITON X-100¹ | 1 ml/L |
| Coumarin² | 1 g/L |
| FeCl₂ | 6 g/L |

¹TRITON X-100 is a well-known surfactant.
²1,2-benzopyrone.

The bath was contained in a reservoir and continuously pumped through an electrolytic cell where the subject metallic substrate was retained and connected as the cathode. The anode used was stainless steel and a current was imposed to provide about 200 Amperes per square foot of surface on the cathode substrate to be coated. The pH was maintained between 1 and 1.5.

As a result of various iterations of the use of such a bath, products were obtained having a coating about 10 microns thick and a consistent proportion of metals as follows: 16-22% Cr, 64-78% iron, and 6-10% nickel, having excellent brightness, levelness and adherence; the product was substantially free of microcracks. Other thicknesses from 1 to 100 micrometers or more are readily obtainable with variations of the duration of electrolysis.

A typical coated carbon steel sample A made in such a bath was found to have a coating containing, in weight percent, 18 chromium, 74 iron, and 8 nickel. Another coated carbon steel sample, B, contained 20% chromium, 74% iron, and 6% nickel by weight in the coating. It was subjected to bend tests at 1200 and 180° (the sheet was bent to 120° and 180° with respect to itself). Tape was applied and removed from the outer surface of the bend. No flaking or powdering of any sort was observed. The same sample was subjected to drop tests of 120 and 150 inch-pounds and again no powdering or flaking was observed when a tape was pulled from the impacted area. On a scale of 0-5, where 0 is the best, “in-house” ratings were awarded as follows: 1200 bend test: 0.0-0.5; 180° bend test: 0.0-0.5; 120 in-lb impact: 0.0-0.5; 150 in-lb impact test: 0.0-0.5. Brightness of virtually all the products made under various conditions within the above stated parameters was similar to monolithic stainless steel or a chrome-plated substrate. No corrosion was observed after 96 hours in 100% humidity at 100° F.

Conversion of the chromium in the bath to the hexavalent state should be minimized; if a significant portion of the chromium is allowed to convert, the desired form of chromium may become quickly depleted and a consistent product will not be made. Moreover, hexavalent chromium is environmentally undesirable, and reduces the efficiency of the electrodeposition process. A major factor in maintaining the chromium in the trivalent state is the use of turbulence in the bath and particularly where the bath contacts the cathode. In the absence of agitation, drifting of the cathodic potential may result in a buildup of Cr⁺⁺. In the case of a preformed, three-dimensional workpiece, the agitation should be provided by a pump or agitator; in the case of steel strip, passing the strip through the bath may be sufficient, or the agitation may be augmented by additional turbulent motion of the bath provided by a pump.

Maintenance of the Metal Contents and Ratios

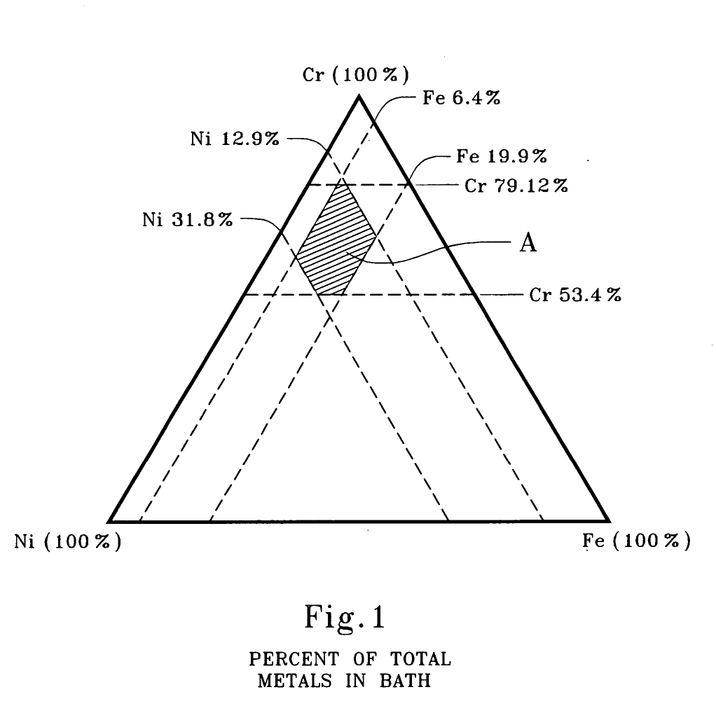

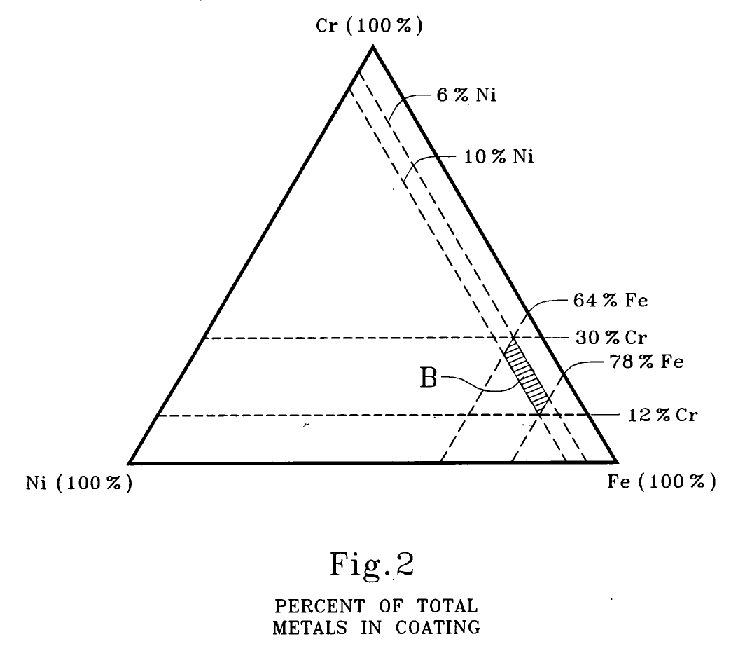

The chromium, nickel and iron contents of the bath are established primarily by the initial concentrations, as indicated above. The rate of deposition of the coating is the main factor in the rates of depletion of the chromium, nickel and iron in the bath, but they are deposited at different rates with respect to each other.—that is, the three metals are deposited at rates and ratios quite different from the ratios of the metals in the bath. This is illustrated in FIGS. 1 and 2. While the original makeup of the bath is preferably stated in terms of the concentrations of the chlorides,—that is, 60-83% of the metals source is chromium (III) chloride, 11-27.7% of the metals source is nickel chloride, and 4.7-15.4% of the metals source is ferrous chloride—the particular source of each metal is not as important as the metals themselves in the bath. These percentages of metal chlorides (weight percentages of the total metal chlorides) are converted in FIG. 1 to percentages of the total of the three metals dissolved in the bath. Thus, when the total of the metal sources in the bath is 60-83% CrCl₃.6H₂O, and the other two metal sources are within the ranges stated herein, chromium is 53.4% to 79.12% of the total metals in the bath; 11% to 27.7% of the total metal sources is NiCl₂.6H₂O and nickel is 12.9% to 31.8% of the total of the three metals in the bath, and iron, derived from 4.7% to 15.4% FeCl₂.4H₂O, is 6.4% to 19.9% by weight of the total of the three metals in the bath. The shaded area A represents the various combinations of percentages of the three metals in the bath. Other halides and/or even other anions may be used in place of the chlorides where it is found they have no harmful effects.

When the three metals are present in the bath in the ratios illustrated in FIG. 1 and the other conditions described herein are observed, the metal cathode acquires a coating of metals having stainless steel composition illustrated in FIG. 2 and described elsewhere herein. Specifically, FIG. 2 shows a shaded area B representing the coating composition wherein the chromium content is 12% to 30% by weight, the nickel content is 6% to 10% by weight, and the iron content is 64% to 78% by weight. Thus our invention includes a method of forming a stainless steel coating on a steel substrate, where the stainless steel coating comprises chromium, nickel and iron within the range of weight ratios chromium 6-15: nickel 3-5: iron 32-39 comprising electrolytically depositing the three metals from an aqueous electrolyte containing chromium, nickel and iron dissolved in weight ratios of chromium 53.4-79.12: nickel 12.9-31.8: iron 6.4-19.9. Similar coatings may be deposited on other metal cathodes.

The two shaded areas A and B of FIGS. 1 and 2 are clearly far removed from each other, reflecting the different rates of deposition of the three metals. Ideally, the metals are deposited in the ratios illustrated in FIG. 2 and in amounts calculable from the coating weights and areas, but in practice depletion of the metals in the bath may vary from facility to facility, as a function of the applied current, with the concentrations of the dissolved metals, and with their ratios to each other within area A. Therefore the preferred method of maintaining effective concentrations and ratios of the metals to each other is to take samples periodically, analyze for the metals, and replenish the bath incrementally—that is, remove a portion of the used bath and replace it with the same amount of new solution containing concentrations and ratios of the three metals calculated to replace the deposited metals. Where a stainless steel anode is employed, some dissolution of the anode may be expected, contributing metals to the bath at rates generally in accord with the anode's composition, but which may vary somewhat over time. Over a long period, experience will enable persons skilled in the art to construct models of the process so that the bath may be replenished more or less continuously, whether or not a stainless steel anode is used. Also, it may be useful to design an anode specifically as a sacrificial anode to continuously and entirely replace the metals in the bath in the amounts and proportions they are deposited, thus avoiding or minimizing the need to use new solution for replacing the metals.

While any stainless steel composition may be used for the anode, it may be useful to design an anode specifically as a sacrificial anode to continuously substantially replace the metals in the bath in the proportions and amounts they are deposited on the cathode, thus avoiding or minimizing the necessity of replenishing the dissolved metals by removing and replacing bath solution.

The Leveling Agents

Leveling agents and brighteners are desirable to enhance the product quality. A leveling agent is an additive for the bath which influences the rate of deposition and thickness of the deposited metals over large and small areas, generally assuring that the deposition is evenly conducted especially over areas which might include microscopic pits or peaks. In the absence of a leveling agent, stress is built in to the coating, resulting in a rough surface. In our preferred process and bath, we use both citric acid and coumarin as leveling agents, but if only one is to be used, we prefer coumarin. In addition to functioning as a leveling agent, coumarin is a brightener. Brighteners provide a more even, shiny, or bright surface. The leveling effect of a leveling agent is substantially similar to the brightening effect of a brightener; the two terms and effects may be used interchangeably, and where we refer herein to brighteners or brightening we intend equivalence to leveling agents and leveling effects. While coumarin (1,2-benzopyrone) is preferred, related compounds and isomers may be used, such as 2,1-benzopyrone, 1,4-benzopyrone, 3-chlorocoumarin, 3-bromocoumarin, 3-acetylcoumarin, 7-hydroxxyethyl coumarin, 6-chlorocoumarin, 4,8-dimethyl coumarin, 8-methoxycoumarin, 7-ethoxycoumarin, 6-propargoxy coumarin, and 6-acetamido coumarin. These and other coumarin derivatives are described as leveling agents in the following US Patents: Faust et al U.S. Pat. No. 2,840,517, Tomaszewski et al U.S. Pat. No. 3,268,307, Du Rose et al U.S. Pat. No. 3,414,491, Klein et al U.S. Pat. No. 3,719,568 and U.S. Pat. No. 3,795,592, and Tremmel U.S. Pat. No. 4,441,969. Coumarin and the coumarin derivatives listed above and any others described as effective leveling agents in electrolytic baths are defined as, and may be called herein, “coumarin leveling agents.” Coumarin leveling agents may be used in small amounts effective in our aqueous electrolytic bath to brighten the coating and/or distribute the metals substantially level over a metallic surface which might not be substantially level microscopically.

As is indicated in the above patents, coumarin may be expected to break down in the bath to melilotic acid, also known as 3-(2-hydroxyphenyl) propionic acid, which can have adverse color effects on the product. Accordingly, we may continuously or intermittently pass at least part of the bath through a filter or absorbent to remove the melilotic acid; we prefer to use a bed of activated carbon, but an ion exchange resin such as Amberlite may be useful in some facilities to remove melilotic acid from the solution. Where a coumarin leveling agent other than coumarin is used, breakdown products other than melilotic acid may be produced; we do not intend to be limited to the removal of melilotic acid by filtration, adsorption, or otherwise. Also, the filter, absorbent, or resin may remove some of the coumarin as well as the melilotic acid. Whether or not undegraded coumarin is removed in the filtering or adsorption process, the converted or removed coumarin may be replenished continuously or intermittently either in the same solution used to replenish the metals or in a separate addition. Various additives have been used in electrolytic baths to complement the action of the coumarin leveling agent and/or to ameliorate its breakdown. Such additives include water soluble acetylenic compounds (U.S. Pat. Nos. 3,111,466 and 3,414,491), propylene oxide adducts of propargyl alcohol (U.S. Pat. No. 3,719,568), butyne diol, formaldehyde, and chloral hydrate (U.S. Pat. No. 4,441,969). Such additives may be called coumarin complements; they are compatible with, and may be useful in, our process.

Other constituents of the bath are not consumed at significant rates in the process, but should nevertheless be monitored occasionally in a continuous process.

The pH of the bath may be maintained by the citric acid and to a lesser extent the ammonium chloride. Little adjustment of the pH, if any, will be required, but, any conventional method of maintaining a desired acid pH in a plating bath may be used if necessary.

The hydrofluosilicic acid improves the deposition of chromium and contributes to the enhanced shininess of the product attainable by our process.

The “Triton X-100” is a stress reliever—that is, it inhibits the formation of microcracks in the coating as it builds, thereby alleviating the potential for corrosion. Other surfactants may perform in much the same manner. Other stress relievers include formates, acetates, and salicylic acid. Many surfactants and other stress relievers also have the property of alleviating the undesirable tendency, sometimes noticeable, of the coumarin leveling agent to induce tensile stress or brittleness in the coating. Where a stress reliever is used, the concentration of brightener (coumarin leveling agent) may be reduced.

Our coated metal products may be used in many applications in place of conventional stainless steel; for example they are ideal for architectural uses, appliances, automotive parts, and anywhere steel is used, where corrosion resistance is important, and/or especially where an attractive, readily polished appearance is desired without the necessity of painting.

1-17. (canceled)

18. A coated metallic substrate product made by the method comprising employing said metallic substrate as a cathode in an aqueous electrolytic bath comprising 35-65 grams per liter chromium chloride. 9-15 grams per liter nickel chloride, and 4-8 grams per liter ferrous chloride, and a leveling agent in an amount effective to enhance brightness in said coating, subjecting said bath to an electric current effective to deposit chromium, nickel and iron as a coating on said substrate while maintaining said metallic substrate in turbulent contact with said bath, removing said metallic substrate from said bath and heat treating it whereby said metallic substrate has a corrosion resistance similar to that of stainless steel.

19. Steel having a coating comprising 12-30% chromium, 6-10% nickel, and 64-78% iron, said coating being substantially free of microcracks, having a brightness similar to monolithic stainless steel, superior adherence as demonstrated in fold and drop tests, and a substantially consistent distribution of chromium, nickel and iron throughout said coating.

20. Steel of claim 19 wherein said coating comprises 16-22% chromium, 7-9% nickel, and 71-76% iron.

21. Steel of claim 19 wherein said coating is 1-100 micrometers thick.

22. Steel of claim 19 having an undercoat of nickel.

23. An article made of the steel of claim 19.

24. An aqueous solution useful as an electrolytic bath for depositing a coating of stainless steel on a metallic substrate comprising 35-65 grams per liter chromium chloride, 9-15 grams per liter nickel chloride, and 4-8 grams per liter ferrous chloride, said solution having a pH of 0.8 to 2.0 and including a small amount of hydrofluosilicic acid and a small amount of a coumarin leveling agent.

25. An aqueous solution of claim 24 including at least one of (a) ammonium chloride in an amount up to 100 g/L, (b) potassium chloride in an amount up to 60 g/L, and (c) citric acid in an amount up to 100 g/L.

26. Method of forming a stainless steel coating on a steel substrate, said stainless steel coating comprising chromium, nickel and iron within the range of weight ratios chromium 6-15 : nickel 3-5 : iron 32-39 comprising electrolytically depositing said metals from an aqueous electrolyte containing chromium, nickel and iron dissolved in weight ratios of chromium 53.4-79.12 : nickel 12.9-31.8: iron 6.4-19.9.

27. Method of claim 26 wherein said aqueous electrolyte also includes a coumarin leveling agent in an amount effective to improve brightness of said coating.

28. Method of claim 27 which is continuous and wherein a breakdown product of said coumarin leveling agent is continuously or intermittently removed from said aqueous electrolyte.

29. Method of claim 26 wherein said chromium, said nickel, and said iron are present in said aqueous electrolyte substantially entirely in the form of chlorides.

30. Method of claim 26 wherein said chromium in said aqueous electrolyte is substantially entirely trivalent.
